(19) United States
(12) Patent Application Publication
(10) Pub. No.: US 2026/0245544 A1
(43) Pub. Date: Aug. 20, 2026

(54) AUDIO PROCESSING

(71) Applicant: Polymina Limited, Ramsey, British Isles (IM)

(72) Inventors: Jason KELLY, Ramsey (IM); David BROWN, Ramsey (IM)

(21) Appl. No.: 19/161,588

(22) PCT Filed: Mar. 1, 2024
(86) PCT No.: PCT/GB2024/050563

§ 371 Date: Sep. 2, 2025

(30) Foreign Application Priority Data
Mar. 2, 2023 (GB) 2303121.4

(51) Int. Cl. G10L 13/08; G06F 40/143; G06F 40/166; G06F 40/279; G10L 13/033

(52) U.S. Cl. CPC G10L 13/08; G06F 40/143; G06F 40/166; G06F 40/279; G10L 13/033

(57) ABSTRACT

A method of processing audio performed by one or more computers. The method includes processing received content to identify a first section of the content and plurality of subsections. A respective audio representation of each of the plurality of subsections is generated. A user interface is provided for input, by a user, of an indication of an audio modification to be made to the generated audio representation. A user input is received that indicates an audio modification and an extent indicator that indicates whether the audio modification is to be applied to the first section or to only one of the plurality of first subsections and modifying the generated audio based on the user input.

### CROSS-REFERENCE TO RELATED APPLICATIONS

This application is the U.S. National Stage entry of International Application No. PCT/GB2024/050563, filed on Mar. 1, 2024, which, in turn, claims priority to GB Patent Application No. 2303121.4, filed on Mar. 2, 2023, both of which are hereby incorporated herein by reference in their entireties for all purposes.

### FIELD

The present invention relates to a computer implemented method, system and computer software product for processing audio.

### BACKGROUND

While technologies such as text-to-speech generators and standardised mark-up languages such as Speech Synthesis Markup Language (SSML) are making it easier to generate audio content from text content, editing the resultant audio content with existing tools require skilled editors and editing is often a laborious process.

Additionally, the text-to-speech process is often performed remotely from the user, such as on a remote server. Editing of the resultant audio content cannot be performed until the user receives the generated audio content from the server. This results in editing that cannot be performed in real-time and which requires transmission of large amounts of data over a network in an iterative editing processes.

### SUMMARY OF INVENTION

In an example described herein, a method of processing audio is performed by one or more computers. The method comprises receiving an indication of text content and processing the text content to identify a first section of the text content and plurality of subsections of the first section. An audio representation of the first section is generated, the audio representation of the first section comprising a respective audio representation of each of the plurality of subsections. The method may include providing, at an output of the one or more computers, a user interface for input, by a user, an indication of an audio modification to be made to the generated audio representation. A user input is received, the user input indicating an audio modification and an extent indicator that indicates whether the audio modification is to be applied to the first section or to only one of the plurality of first subsections.

In response to the extent indicator indicating that the audio modification is to be applied to the first section, the method includes generating updated audio representations for a plurality of subsections of the first section in accordance with the indication of the audio modification. In response to the extent indicator indicating that the audio modification applies only to one of the plurality of first subsections, the method includes generating an updated audio representation for the one of the plurality of first subsections in accordance with the received indication of the audio modification.

In this way, a user interface may be provided that enables a user to edit audio content in real-time by enabling specification of edits to audio generated for individual subsections or modifications of audio to apply to entire sections. Techniques described herein may be particularly beneficial for generation of audiobooks, for example. Furthermore, by providing a user interface to enable users to specify edits to audio corresponding to particular subsections of content, the system enables editing of text content to be performed ‘at scale’. By enabling editing to happen at the subsection level, the audio processing application can process edits for many users editing many texts in real-time, simultaneously.

Modification of audio may be modification of any one or more audio characteristic. For example, modification to audio may comprise modification of pitch, volume, speed, speech flow, loudness, intonation, intensity of overtones, articulation, speech pauses, speech rhythm, etc. Modification may include selecting from one or more preset voices

The representation of text content may take any appropriate form. For example, the representation may take the form of one or more documents. For example, the representation may comprise one or more documents in plaintext, Word doc, PDF format, or text documents in any other format.

The text content may be a book. The final audio output may be an audiobook.

The method may include specifically determining, based on the extent indicator, whether the audio modification applies to only one of the plurality of first subsections or to the entire section. The user input may indicate an audio modification is one of a plurality of user inputs, each of the plurality of user inputs indicating a respective audio modification. One or more of the plurality of user inputs has a different extent indicator. That is, different ones of the plurality of user inputs may apply to different extents. The method may further comprise, in response to the extent indicator indicating that the audio modification is to be applied to the first section, determining one or more of the plurality of subsections to which the audio modification applies. Generating updated audio representations for the plurality of subsections of the first section in accordance with the indication of the audio modification may comprise generating updated audio representations for the determined one or more of the plurality of subsections. In this way, the method is able to avoid unnecessarily generating modifying audio and transmitting unnecessarily modified audio to the user.

Determining one or more of the plurality of subsections to which the audio modification is to be applied may comprises determining that the audio modification applies to each of the plurality of subsections. For example, an audio modification may be a change to audio that is present in every subsection, for example audio associated with a narrator. Alternatively, determining one or more of the plurality of subsections to which the audio modification applies may comprise determining that the audio modification does not apply to all of the plurality of subsections.

The user input may include an indication of one or more entities associated with the audio modification. The method may further comprise, in response to the extent indicator indicating that the audio modification is to be applied to the first section, determining one or more of the plurality of subsections to in which the one or more entities is indicated. Generating updated audio representations for a plurality of subsections of the first section in accordance with the indication of the audio modification may comprise generating updated audio representations of the one or more of the plurality of subsections to in which the one or more entities is indicated.

Generating an audio representation may comprise providing at least a portion of the text content to a text-to-speech generator. The text-to-speech generator may be any text-to-speech processor as would be known to the skilled person. For example, the text-to-speech processor may comprise one or more machine-learned models. Providing at least a portion of the text content as an input to a text-to-speech generator comprises generating a modified portion of the text content, and providing the modified portion to the text-to-speech processor. For example, at least a portion of the text content may be processed to generate a marked-up version of the text content. It will be appreciate that any suitable markup language may be used, such as SSML, XML more generally, or any other.

Generating an updated audio representation may comprise modifying at least a portion of the text content and/or further modifying at least a portion of a marked-up version of the text content. The modified text content or further modified text content may be provided as an input to a text-to-speech generator. For example, one or more tags in a marked-up version of the text content may be modified to indicate the audio modification to be applied.

The first section may be a chapter of a book. The subsections may be lines within the chapter. For example, individual lines may be separated by new-line characters, such as Line Feed (LF) or Carriage Return (CR). The subsections may be individual sentences within the chapter. For example, individual sentences may be separated by punctuation. The first section may be a plurality of chapters and the subsections may be a single chapter.

Processing the representation of text content to identify a first section of the text content and plurality of subsections of the first section, may comprise processing the representation of text content to identify a plurality of sections of the text content and to identify, for each of the plurality of sections, a respective plurality of subsections. The user input may indicate that the audio modification is to be applied to the first section and further indicates that the audio modification is to be applied to the plurality of sections. The method may include, in response to the user input indicating that the audio modification is to be applied to the plurality of sections, processing the text content to determine one or more of the plurality of sections to which the audio modification applies. For example, where the audio modification applies to a particular entity, the text content may be processed to determine the sections in which the entity is present.

The method may further comprise generating a final audio output comprising one or more generated and/or updated audio representations. For example, the final audio output may comprise an audio representation for the entirety of the text content.

The method may comprise processing the text content to determining one or more entities referenced in the text content. An entity map may be generated, the entity map mapping individual entities to respective sections of the text content.

The method may further comprise processing the text content to determine one or more notes. There may be generated, for each of the one or more notes, an audio representation of the note. The method may comprise providing, at the output of the one or more computers, a user interface element to enable the user to select one or more locations in a final audio output at which the audio representations of the notes should be included. For example, a user interface element may be provided to enable a user to easily select whether audio corresponding to footnotes is placed at any one or more of: the end of the final audio output, at the end of the audio output of the respective chapters in which the footnotes are present, at the end of the audio output of the respective pages in which the footnotes are present, at the end of the respective paragraphs in which the footnotes are present, at the end of the respective lines in which the footnotes are present, at the end of the respective sentences in which the footnotes are present or in-situ, i.e. after a particular word.

One or more image identifiers may be identified in the text content. The image identifies may be actual images or may be references to an image.

In another example described herein, one or more non-transitory computer readable media store computer program code configured to cause one or more computers to perform any of the methods or method steps described herein.

In another example described herein, one or more computers comprise one or more processors and one more non-transitory memories storing computer program code configured to cause the one or more computers to perform any of the methods or method steps described herein.

### BRIEF DESCRIPTION OF DRAWINGS

Embodiments will now be described, by way of example only and with reference to the accompanying drawings having like-reference numerals, in which:

FIG. 1 shows a schematic illustration a system suitable for implementing one or more techniques described herein;

FIG. 2 is a schematic illustration of an example arrangement of components that may be used in one or more devices of the system of FIG. 1;

FIG. 3 is a flowchart showing example processing that may be carried by one or more devices of the system of FIG. 1; and

FIG. 4 is an example user interface that may be provided by one or more devices of the system of FIG. 1.

FIG. 5 is a further example user interface that may be provided by one or more devices of the system of FIG. 1.

FIG. 6 is a further example user interface that may be provided by one or more devices of the system of FIG. 1.

FIG. 7 is a further example user interface that may be provided by one or more devices of the system of FIG. 1.

### SPECIFIC DESCRIPTION

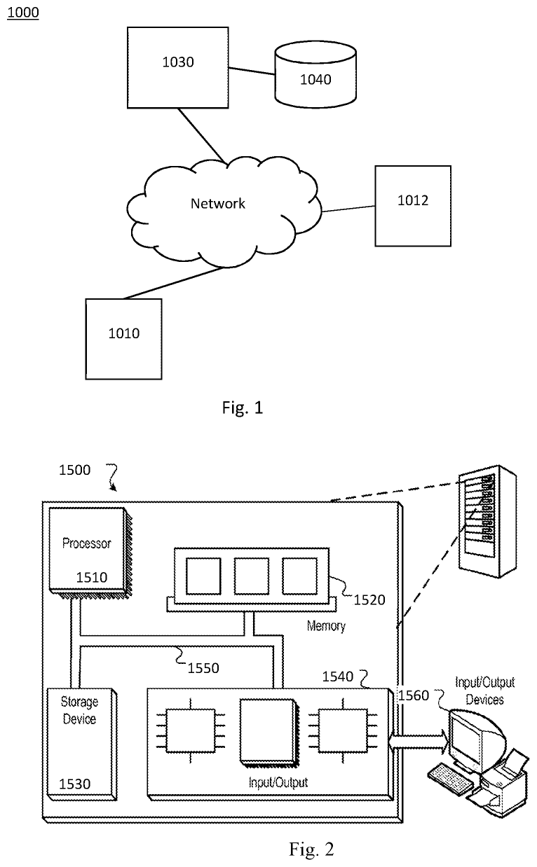

Referring to FIGS. 1 to 7, the details of methods, systems and a computer software product for processing audio will now be described in more detail below. The use of the same reference numbers in different instances in the description and the figures may indicate like elements.

Referring to FIG. 1, there is shown a computer system 1000 suitable for implementing parts of the methods described herein. In the system 1000, a user device 1010 is configured to communicate over a network with a server 1030. While only a single user device 1010 is depicted, it will be appreciated that any number of user devices may communicate with the server 1030. The server has access to storage 1040. For example, the storage 1040 may be local to the server 1030 (as depicted in FIG. 1) or may be remote. While the storage is depicted as a single storage 1040, it will be appreciated that the storage 1040 may be distributed across a plurality of devices and/or locations. The server 1030 is configured to make available over the network one or more applications for use by the user device 1010. In particular, the server 1030 is configured to make available an audio processing application for assisting a user of the user device 1010 in generating and processing audio. The audio processing application provides a user interface that receives inputs from the user and processes the inputs to generate audio and to perform processing on the generated audio in order to modify the generated audio. The audio processing application may be accessed by the user device 1010 through, for example, a web-browser or a client application operating locally on the user device 1010.

The storage 1040 may store data (e.g. in one or more databases) used by the audio processing application. For example, the storage 1040 may store audio that is generated or processed by the audio processing application. The storage 1040 may further store machine-learning models used by the audio processing application to process user inputs. The storage 1040 may further store individual profiles and credentials for respective users of the audio processing application so that a user's inputs and generated audio may be uniquely and securely identified with that user.

The server 1030 and/or the user device 1010 may be in further communication with one or more third party devices 1012, such as third party servers. The audio processing application may transmit to or receive from, information generated during use of the audio processing application to the one or more third party devices 1012, or may automatically communicate with third party devices 1012 to cause services to be scheduled or provided by third parties associated with the third party devices 1012. For example, the third party devices 1012 may store information relating to original content used to generate audio by the audio processing application and such information may be retrieved from the third party devices 1012 during generation or modification of the audio.

Each of the user devices 1010 may be any device that is capable of accessing the audio processing application provided by the server 1030. For example, the user devices may include a tablet computer, a desktop computer, a laptop, computer, a smartphone, etc.

The audio processing application provided by the server 1030 provides an interface to output information to a user and to enable a user to input information.

Referring to FIG. 2, there is shown an example computer system 1500 that may be used to implement one or more of the user device 1010, the server 1040 and the third party device 1012. The methods, models, logic, etc., described herein may be implemented on a computer system, such as the computer system 1500. The computer system 1500 may comprise a processor 1510, memory 1520, one or more storage devices 1530, an input/output processor 1540, circuitry to connect the components 1550 and one or more input/output devices 1560. While schematic examples of the components 1510-1550 are depicted in FIG. 2, it is to be understood that the particular form of the components may differ from those depicted as described in more detail herein and as will be readily apparent to the skilled person.

There is now described a number of examples of audio processing that may be facilitated by an audio processing application in accordance with techniques described herein.

As described above, the audio processing application may allow a user to generate an audio output based on text content. For example, the audio processing application may allow a user to generate an audiobook from a book represented in received text content.

As described above, the audio processing application may allow a user to create an account or unique session and to access their account or session using appropriate identifiers and/or security tokens. One or more audio content generation tasks may be associated with the user's account or unique session, for example to allow the user secure access to their audio content generation tasks and/or to restrict access to others. Any appropriate account or session management processes and systems may be used to allow the audio processing application to administer user accounts as will be well known to the person skilled in the art. As described above, the audio processing application provides a user interface by which a user may interact with the audio processing application. A login user interface may be provided to enable a user to access their account.

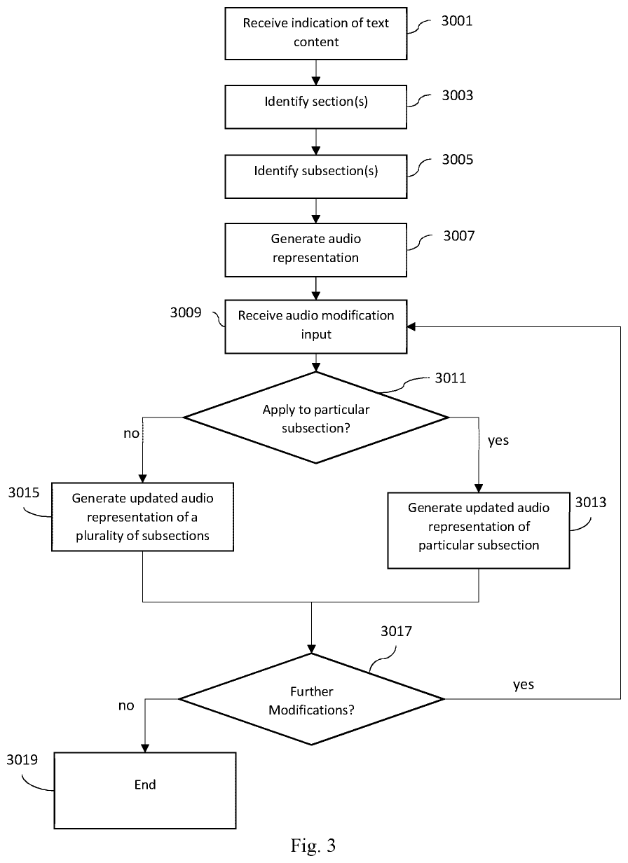

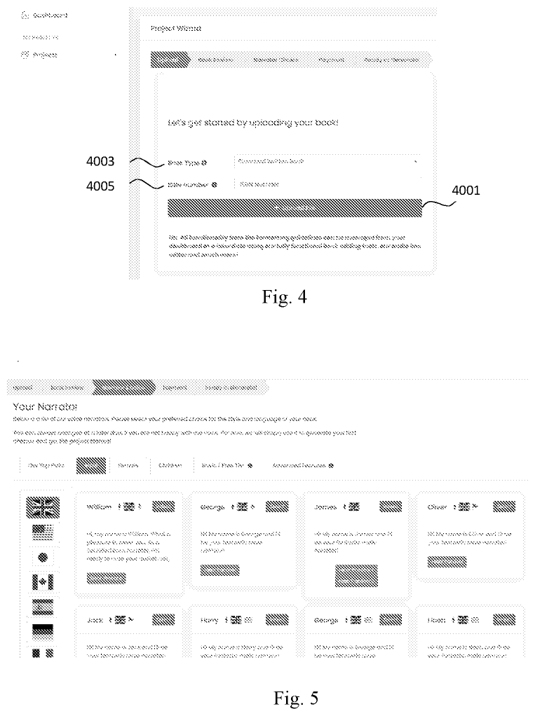

Referring now to FIG. 3, at step 3001, the audio processing application receives a representation of text content. For example, the audio processing application may receive an input from the user of a file containing text. Alternatively, the audio processing application may receive a reference to a file containing text. The audio processing application may provide a user interface to enable a user to provide the indication of text content. An example text input user interface is shown in FIG. 4. In the example of FIG. 4, a user interface element 4001 is provided to enable a user to select a file containing text content to input. A “book type” user interface element 4003 is provided to enable a user to select a type of text content that is being input. For example, selection of the Book Type user interface element 4003 may display a list from which a user can select. Selection of an option within the Book Type list may affect generation or modification of the audio content. For example, the Book Type list may include “Standard Written Book”, “Poetry”, “Academic Book”, “Book Featuring Illustrations”, “Children's Book” and “Unformatted Line Endings Book”. By way of example, selecting “Academic Book” may cause the audio content generation to automatically process notes, as will be described in more detail below. Additionally or alternatively, selection of an option from the Book Type list may cause meta-data to be associated with generated audio content to facilitate further processing of the audio content, for example searching.

An ISBN Number user interface element 4005 is also provided in the example user interface of FIG. 4. Input, by a user, of an ISBN number in the user interface element 4005 may cause the audio processing application to retrieve information, for example from the third party 1012.

Referring again to FIG. 3, processing passes from step 3001 to step 3003 at which the audio processing application processes the text content received at step 3001 to determine one or more sections. For example, the audio processing application may parse the text content to identify chapters. Identification of sections may be performed in any appropriate way. For example, identifying sections may comprise identifying section headings/titles. Section headings may be identified in any appropriate manner. For example, the text content may provide an indication of section titles in a predefined format, such as in a contents page or a table. Alternatively or additionally, section titles may be identified based upon formatting used in the text content, such as font size, emboldening, underlining, etc. Alternatively or additionally, the text content may be processed by a machine-learned model (such as a natural language processing model, such as a model including one or more self-attention layers, such as a Transformer based model, such as a so-called Large Language Model), trained to identify section titles. The audio processing application may generate a list of sections. The audio processing application may split the received text content into multiple sections based on the identified sections. For example, the received text content may be split into multiple files, each file containing a single section.

Processing passes from step 3003 to step 3005 at which subsections are identified for one or more of the identified sections. In one example, subsections may initially be identified only for the first section. Alternatively, subsections may be identified for each of the sections identified at step 3003. Subsections may be individual lines. For example, individual lines may be separated by new-line characters, such as Line Feed (LF) or Carriage Return (CR). The subsections may be paragraphs. The subsections may be individual sentences within the chapter. For example, individual sentences may be identified by punctuation.

The subsections within a section may be represented internally in any appropriate way. For example, a new file may be created for each subsection. Alternatively, a list or index may be created to indicate the subsections within a section.

Processing passes from step 3005 to step 3007 at which an audio representation is generated. The processing at step 3007 may include generating or receiving a marked-up representation of at least a portion of the text content. For example, the processing at step 3005 may include generating a Speech Synthesis Markup Language representation of the text content. Generation and or receipt of the marked-up representation of the text content may be performed in any appropriate way and may use readily available tools. For example, the way in which SSML files are generated will be well known to the skilled person and as such is not described in detail herein. It will be equally apparent to the skilled person that any other appropriate mark-up language may be used, including custom mark-up languages.

To generate the audio representation at step 3007, a number of default or predefined parameters for the audio generation may be used, as will be known to those skilled in the art of text-to-speech. For example, parameters such as speaking rate, tone, pitch, or any other parameter of the audio may be pre-set. Additionally or alternatively, the audio processing application may provide the user with a user interface to enable the user to select one or more parameters with which to generate the audio representation at step 3007. An example user interface is depicted in FIG. 5, which provides a plurality of user interface elements to assist a user in quickly and easily selecting parameters for generation of the audio. In the example user interface of FIG. 5, user interface elements are provided to enable users to select voices for the narrator of the audio content, each narrator having different characteristics.

The parameters of the audio generation, whether predetermined or selected may be represented in a marked-up representation of the text content, such as an SSML file using appropriate tags as will be readily apparent to the skilled person.

The audio representation may initially be generated only for the first section. In this way, the audio modification application can allow a user to modify characteristics of the generated audio before generating audio for all of the sections, thereby reducing the number of iterative modifications that are made and reducing bandwidth by avoiding the transmission of audio for the entire text content. Alternatively, audio representations may be generated for a plurality of sections, or for all sections.

The audio representation of a section includes audio representations of each subsection within the section. For example, the audio representation of a paragraph may include respective audio representations for each line within the paragraph. The respective audio representations of each subsection may be separate audio representations. In this way, the audio processing application can provide the user with a user interface to enable updating of a single subsection, without the need to update the audio representation of the entire section. Alternatively, the audio representation of the section may contain data (e.g. flags) within the bitstream of the audio representation to indicate where subsections begin and/or end.

Processing passes from step 3007 to step 3009 at which the audio processing application receives a user input indicating an audio modification to be applied to the generated audio content. The user input may comprise an extent indicator that indicates an extent to which the audio modification applies to the generated audio representation. For example, the extent indicator may indicate that the audio modification applies only to a particular subsection of the generated audio representation. The extent indicator may alternatively indicate that the audio modification applies to the entire section.

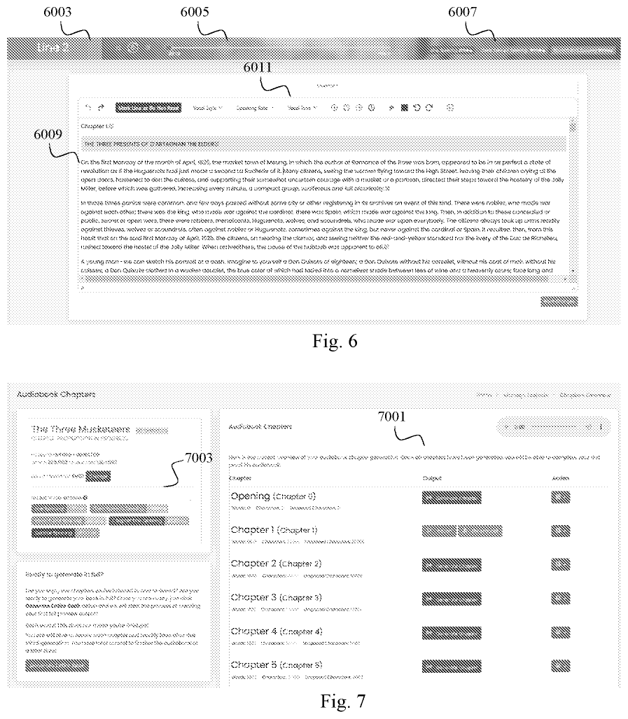

The audio processing application may provide a user interface to enable a user to efficiently input modifications and extent indicators to be processed by the audio processing application in order to modify the generated audio representation. Example user interfaces are depicted in FIGS. 6 and 7. FIG. 6 depicts a “line editor” user interface comprising a current line indicator 6003, a playback control panel 6005, section modification elements 6007 and a line selection and editing panel 6009, and line modification elements 6011. The user can use the user interface of FIG. 6 to select and modify lines of the text content of a particular section. In the example shown in FIG. 6, a user has selected ‘line 2’ of a section. A user can input a number of line-specific audio modifications, such as editing the text of the particular line, changing vocal style, speaking rate, vocal tone, or marking a line as “Do Not Read”, for example. When selecting a line-specific audio modification element to input an audio modification, the extent indicator will indicate the specific line. Additionally, the user may make audio modifications to the entire section using the section modification elements 6007. When selecting a section modification element 6007, the extent indicator will indicate the entire section.

FIG. 7 depicts a Chapter Overview user interface comprising a chapter list 7001 and a number of global modification user interface elements 7003. A user may use the chapter list 7001 to launch the line editor user interface (e.g. as shown in FIG. 6) for the particular chapter. The user may also input audio modifications to be applied to the entire text using the global modification user interface elements 7003, such as specifying the narrator, chapter title spacing, speech end spacing, etc.

It will be appreciated that the extent indicator may not be specifically encoded and may be inferred by the audio modification program based upon a user interface element selected and/or a context of the user interface, such as whether the user interface is in a line editor or a chapter overview. That is, the extent indicator may comprise specific and/or dedicated data (e.g. a specific bit or sequence of bits) encoded in a user input, but may be inferred from data in the user input and a context of the user interface. For some user inputs, the extent indicator may comprise specific and/or dedicated data encoded in the user input.

Referring again to FIG. 3, the processing passes from step 3009 to 3011 where processing branches based upon whether the extent indicator indicates that the audio modification applies to a particular subsection or to an entire section. If the extent indicator indicates that the audio modification applies to a particular subsection, processing passes to step 3013 and an updated audio representation of the particular section is generated. If the extent indicator alternatively indicates that the audio modification applies to the entire section, processing passes to step 3015 at which updated audio is generated for a plurality of subsections of the section. The processing at step 3015 may comprise generating updated audio for the entire section (i.e. each of the plurality of subsections). For example, where the audio modification is indicated by selection of one of the elements 6007, the processing at step 3015 may comprise generating updated audio for the entire section.

Processing passes from step 3013 or 3015 to step 3017 at which it is determined whether there are further modifications. For example, a determination that there are no further modifications to correspond to a user selecting the ‘save changes’ button shown in FIG. 6, or the ‘generate entire book’ button shown in FIG. 7. In any event, if it is determined that no further modifications, processing ends at step 3019. If it is alternatively determined at step 3017 that further audio modifications are to be made (for example if a user inputs a further audio modification), processing passes back to step 3009. It will be appreciated that the audio processing application may not perform an explicit check as to whether further modifications are made, but may simply restart the processing at step 3009 when further user input is received.

While depicted that updated audio representations are generated separately for each audio modification input before determining if there are further modifications, it is also possible that a plurality of audio modification inputs may be received and updated audio may be generated based on each of the of the audio modification inputs together. Different ones of the plurality of audio modification inputs may have a different extent.

In some examples, the audio application processes a single section at a time. For example, after identifying the sections at step 3003, the audio application may process a first section before processing further sections. That is, the audio processing application may perform processing steps 3005 to 3019 only for the first section. The audio processing application may enable the user to review the first section and prompt a user to confirm that they wish to proceed with processing one or more remaining sections. As such, the final audio output generated at step 3015 may be a final audio output of a single section, a plurality of sections, or all of the identified sections. Referring again to FIG. 7, it can be seen that only a first chapter has been generated and the user is provided with an option to generate the entire book, or to continue generating individual chapters. In this way, a user can avoid generation of audio content for an entire text before editing the audio of specific sections and subsections of that text, thereby reducing bandwidth and processing used in iterative editing of entire texts.

Once every section has been processed (i.e. an audio representation of every section has been generated and, where applicable, audio modifications have been made), the audio processing application may generate a final audio output by combining the audio output of each section into a single audio output. The final audio output may be transmitted from the server to the user device, or may be further processed by the server. For example, the final audio output may be added to a digital store and made available for others to access.

Generating the final audio output may comprise combining audio content for multiple sections. Each section may have been edited a number of times. The audio processing may therefore maintain indications of which of multiple audio content is the latest audio content for a particular section (i.e. the latest edit). The audio processing application may produce the final audio output by combining the latest audio content for each section. Similarly, generating audio content for a section may comprise tracking which of multiple edits to a subsection is the latest edit and generating the audio content for a section by combining the audio content corresponding to the latest edits for each section.

By providing an audio processing application that identifies sections and subsections of text content, and which provides a user interface allowing editing of individual subsections, sections or the entire text, methods described herein enable real-time editing of audio content generated from text.

After the processing of FIG. 3 has been completed for a particular section, the audio processing application may have generated an updated marked-up version of the text content for that particular section, the updated marked-up version representing each of the audio modifications that have been made during the processing of FIG. 3. After the processing of FIG. 3 has been completed for every section, the audio processing application may have generated an updated marked-up version of the entire text content, the updated marked-up version representing each of the audio modifications that have been made.

While not depicted in FIG. 3, the audio processing application may determine one or more entities present in the text content. The determined entities may be distinct sources of audio, such as speech, in generated audio representations. For example, an entity may be a character that is a source of speech or thought. An entity may be some other object that is a source of audio output, such as any object to which sounds or “thoughts” are attributed in the text content, such as a radio, speaker, computer, etc. Where a list of entities has been determined, the audio processing application may provide a user interface to enable a user to specific audio modifications that apply only to specific entities. For example, the audio modification application may enable a user to change any audio parameters for that character, either within a specific subsection (such as a line, sentence, paragraph, chapter) or an entire section (such as a chapter, or audio content for the entire text). For example, the user interface may allow a user to select a specific character and then to input modifications to audio parameters for that character such as voice (e.g. select an entirely different voice from that of the narrator), a tone, pitch, speaking rate, etc.

Entities may be determined in any appropriate way. By way of example, the text content received at step 3001 may be compared to a dictionary of names. For example, the audio modification application may first identify strings that match a particular format, such as:

$$\{ First Name from dictionary \} \_ \{ A - Za - z … a - z \}$$

Where:
First Name exists in the dictionary
_is a space
{A-Za-z . . . a-z} is a word starting with a capital letter and has subsequent alphabetic characters.

This may result in a list of names which may be used to generate an entity map, mapping text content (and therefore audio output) to identified entities, as discussed below. Pronouns may be assigned to entities based on traditional use for a first name, which may be stored in the dictionary of names or retrieved from a third party.

To generate an entity map, each section of the text content may be processed to identify matches against both full name and first name to create a Section Entity List. Example processing may include, for each section:
If there is a single entity, or only two entities of different genders, and names are present in the section, “he said”/“she said” markers (and other identifiers based on gender) may be identified where quotation marks are present,
Where multiple characters are present of the same gender, the audio processing application may determine explicit references (such as “David said”). The audio processing application may then traverse backwards through the section to assign text to the explicitly referenced entity.

The generated entity map may be presented in the user interface to allow for verification or editing by the user. The audio processing application may provide further user interfaces or user interface elements to enable a user to link particular parts of the text content with a particular entity. By way of example only, the line editor depicted in FIG. 6 may provide a user interface element (not shown in FIG. 6) to enable a user to associate a line or portion of a line with a particular entity.

Alternatively or additionally, the text content may be processed by a machine-learned model (such as a natural language processing model, such as a model including one or more self-attention layers, such as a Transformer based model, such as a so-called Large Language Model) to identify characters and audio output that is attributed to them in the text content. For example, the machine-learned model may be trained to output a character map of the type described above, or to output a list of names, with the character map generated as set out above.

It will be appreciated that other methods of entity determination may be used.

Referring again to FIG. 3, for some audio modification inputs, the processing at step 3015 may comprise determining to which of the subsections of the section the audio modification should apply. By way of example only, where the user input corresponds to a particular entity (for example, the user wishes to modify, in a section, speech of a particular entity), the processing at step 3015 may comprise determining which of the plurality of subsections include audio output attributed to that entity. For example, the processing at step 3015 may process an entity map, generated as discussed above, to determine which lines are “said” or “thought” by a particular entity. The processing at step 3015 may then generated updated audio representations of the determined one or more subsections.

While not depicted in FIG. 3, the audio processing application may be configured to process the text content received at step 3001 to identify one or more notes. Notes may include, for example, footnotes, endnotes, references, etc. For example, the text content may be processed to identify predetermined formatting that indicates the presence of a note. For example, footnotes may be indicated in-line in text content using notation such as:
Line of text[x] Further lines of text
   and
FOOTNOTES
[x: {Footnote details}]

### Where:

together each instance of x forms a set of sequential numbers (e.g. contiguous integers) within the text content or section,
FOOTNOTES is present at the end of the text content, or at the end of each section

It will be appreciated that any other suitable notation may be used.

Alternatively, the text content may be processed by a machine-learned model (such as a natural language processing model, such as a model including one or more self-attention layers, such as a Transformer based model, such as a so-called Large Language Model) that is trained to identify notes in text content.

For each identified note, an audio representation of the note may be generated. The final audio output may include the audio representations of the one or more notes. The audio processing application may provide a user interface (e.g. one or more user interface elements) to enable the user to select one or more locations in the final audio content for inclusion audio representations of the notes. For example, a user interface element may be provided to enable a user to instantly select whether audio corresponding to footnotes is read at all, or its placement. For example, user interface elements may be provided to enable a user to cause audio output corresponding to notes to be at any one or more of: the end of the final audio output, at the end of the audio output of the respective chapters in which the footnotes are present, at the end of the audio output of the respective pages in which the footnotes are present, at the end of the respective lines in which the footnotes are present, at the end of the respective sentences in which the footnotes are present or where a footnote indication is present after a particular word in the text content, immediately following the audio output corresponding to the particular word.

While not depicted in FIG. 3, the audio processing application may be configured to process the text content received at step 3001 to identify one or more images or image locations, either present in the text content or referenced in the text content.

The audio processing application may generate a list of images with associated locations corresponding to locations in the text content (and therefore the audio content). For example, the list of images may indicate that an image is to be displayed when audio content corresponding to a particular page is being played. The image list may be processed by a suitable content player to present the image together with the corresponding audio. It will be appreciated that images may be encoded for playback with the audio in any appropriate manner as will depend upon the content player used to play back the audio. For example, images may provided in a separate file, together with metadata to indicate timings, or may be embedded within the same bitstream as the audio.

Where the text contain a reference to an image, rather than an image itself, the text content may be processed to identify references to images using a predefined notation, such as:
[IMAGE] or . . .
[IMAGE: {Details of the image}]

The audio processing application may provide a user interface (e.g. one or more user interface elements) to enable a user to specify images for each of the identified image references. For example, a user may specify a file containing an image and that file may be associated with a specific image reference. The audio processing application may provide a user interface to enable a user to add a description of an image and may pass the description to an image generator, such as a machine-learned image generator that is trained to generate images based on textual descriptions. For example, the user may be prompted by the user interface to indicate details of the image such as an associated style. A number of image generator models are available and any suitable image generation model may be used as will be apparent to the person skilled in the part.

In some example implementations, the audio modification application provides the user with a user interface to generate audio in one or more languages different to the language of the text content. For example, after the processing of FIG. 3, the user may select one or more languages in which audio content should be generated. The audio processing application may provide the text content, or an updated marked-up version of the text content (as described above), to a translator, which may be a machine-translator to generate a translated version of the text content. The translated version of the text content may be passed to a text-to-speech model to generate translated audio content. Alternatively or additionally, the audio modification application may provide the user with a user interface to select a language after providing the indication of text content at step 3001, i.e. before further processing.

While not depicted in FIG. 3, the audio processing application may process the text to automatically determine one or more key words for moderation. For example, the text content may be processed to cross-reference the text with a one or more keyword dictionaries to identify certain keywords or topics. It will be appreciated that this may happen at any stage. In one example, the automatic moderation is performed after the processing of FIG. 3, to avoid moderating text that will otherwise be adjusted by the user during the processing of FIG. 3.

Identified keywords may be flagged for review by a moderator, along with the applicable line and audio reference so that the moderators can hear the line in context.

After the audio has been produced (for example, post the moderation discussed above), the audio processing application may make the produced audio available to a third party end-user, such as a consumer, via an end-user user interface. For example, the produced audio may be automatically added to a website or webstore that enables the produced audio to be accessed (for example downloaded, streamed or otherwise) via a user interface. In this way the audio processing application enables a user to produce audio from text and to make that audio available to an end-user, in real-time. For example, where the audio takes the form of an audiobook, the audio processing application enables a user to produce the audiobook in real-time and to make available that audiobook, also in real-time.

Any system feature as described herein may also be provided as a method feature, and vice versa. As used herein, means plus function features may be expressed alternatively in terms of their corresponding structure. The terms section and subsection are used herein to generally mean a defined section of text content and subsections of that defined section. The term chapter is used to denote a specific type of section and similarly terms paragraph, line, etc., used to denote specific types of subsections. It is to be understood that where specific terms such as chapter or line are used, the more general terms section and subsection may equally apply.

Any feature in one aspect may be applied to other aspects, in any appropriate combination. In particular, method aspects may be applied to system aspects, and vice versa. Furthermore, any, some and/or all features in one aspect can be applied to any, some and/or all features in any other aspect, in any appropriate combination.

It should also be appreciated that particular combinations of the various features described and defined in any aspects can be implemented and/or supplied and/or used independently.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively, or in addition, the program instructions can be encoded on an artificially generated propagated signal, e.g., a machine-generated electrical, optical, or electromagnetic signal that is generated to encode information for transmission to suitable receiver apparatus for execution by a data processing apparatus.

The term “processor”, “computer” or “computing device” generally refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, logic, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a mark-up language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, the subject matter described in this specification can be implemented on a computer having a display device, e.g., a CRT (cathode ray tube) or LCD (liquid crystal display) monitor, for displaying information to the user and a keyboard and a pointing device, e.g., a mouse or a track-ball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads. Machine learning models can be implemented and deployed using a machine learning framework, e.g., a TensorFlow framework, a Microsoft Cognitive Toolkit framework, an Apache Singa framework, or an Apache MXNet framework or other.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

A computing system can include clients and servers as illustrated in FIG. 1. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular examples of subject matter have been described. Other examples are within the scope of the following claims. For example, the actions recited in the claims can be performed in a different order and still achieve the intended result. As one example, the processes depicted in the accompanying figures do not necessarily require the particular order shown, or sequential order, to achieve the desired results. In some cases, multitasking and parallel processing may be advantageous.

1. A method of processing audio performed by one or more computers, comprising:
receiving an indication of text content;
processing the text content to identify a first section of the text content and plurality of subsections of the first section;
generating an audio representation of the first section, the audio representation of the first section comprising a respective audio representation of each of the plurality of subsections;
providing, at an output of the one or more computers, a user interface for input, by a user, an indication of an audio modification to be made to the generated audio representation;
receiving, via the user interface, a user input, the user input indicating an audio modification and an extent indicator that indicates whether the audio modification is to be applied to the first section or to only one of the plurality of first subsections;
in response to the extent indicator indicating that the audio modification is to be applied to the first section:
generating updated audio representations for a plurality of subsections of the first section in accordance with the indication of the audio modification;
in response to the extent indicator indicating that the audio modification applies only to one of the plurality of first subsections:
generating an updated audio representation for the one of the plurality of first subsections in accordance with the received indication of the audio modification.

2. The method of claim 1, wherein the user input indicating an audio modification is one of a plurality of user inputs, each of the plurality of user inputs indicating a respective audio modification.

3. The method of claim 2, wherein one or more of the plurality of user inputs has a different extent indicator.

4. The method of claim 1, further comprising, in response to the extent indicator indicating that the audio modification is to be applied to the first section, determining one or more of the plurality of subsections to which the audio modification applies; and
wherein generating updated audio representations for the plurality of subsections of the first section in accordance with the indication of the audio modification comprises generating updated audio representations for the determined one or more of the plurality of subsections.

5. The method of any claim 4, wherein determining one or more of the plurality of subsections to which the audio modification is to be applied comprises determining that the audio modification applies to each of the plurality of subsections.

6. The method of claim 1, wherein the user input includes an indication of one or more entities associated with the audio modification.

7. The method of claim 6, further comprising in response to the extent indicator indicating that the audio modification is to be applied to the first section, determining one or more of the plurality of subsections to in which the one or more entities is indicated; and
wherein generating updated audio representations for a plurality of subsections of the first section in accordance with the indication of the audio modification comprises generating updated audio representations of the one or more of the plurality of subsections to in which the one or more entities is indicated.

8. The method claim 1, wherein generating an audio representation comprises providing at least a portion of the text content to a text-to-speech generator.

9. The method of claim 8, wherein providing at least a portion of the text content as an input to a text-to-speech generator comprises generating a modified portion of the text content; and
providing the modified portion to the text-to-speech generator.

10. The method of claim 1, wherein generating an updated audio representation comprises modifying at least a portion of the text content and/or further modifying at least a portion of a marked-up version of the text content; and
providing the modified text content or further modified text content as an input to a text-to-speech generator.

11. The method of claim 1, wherein first section is a chapter.

12. The method of claim 1, wherein processing the representation of text content to identify a first section of the text content and plurality of subsections of the first section, may comprise processing the representation of text content to identify a plurality of sections of the text content and to identify, for each of the plurality of sections, a respective plurality of subsections.

13. The method of claim 12, wherein the user input indicates that the audio modification is to be applied to the first section and further indicates that the audio modification is to be applied to the plurality of sections.

14. The method of claim 13, wherein in response to the user input indicating that the audio modification is to be applied to the plurality of sections, processing the text content to determine one or more of the plurality of sections to which the audio modification applies.

15. The method of claim 1, further comprising generating a final audio output comprising one or more generated and/or updated audio representations.

16. The method of claim 1, further comprising processing the text content to determine one or more entities referenced in the text content; and
generating an entity map, the entity map mapping individual entities to respective sections of the text content.

17. The method of claim 1, further comprising processing the text content to determine one or more notes.

18. The method of claim 17, further comprising generating, for each of the one or more notes, an audio representation of the note; and
providing, at the output of the one or more computers, a user interface element to enable the user to select one or more locations in the final audio output at which the audio representations of the notes should be included.

19. (canceled)

20. The method of claim 1, further comprising identifying one or more image identifiers in the text content.

21. (canceled)

22. One or more computers comprising:
one or more processors;
one more non-transitory memories storing computer readable instructions configured to casus the one or more processors to perform a method of processing audio, comprising:
receiving an indication of the text content;
processing the text content to identify a first section of the text and plurality of subsections of the first section;
generating an audio representation of the first section, the audio representation of the first section comprising a respective audio representation of each of the plurality of subsections;
providing, at an output of the one or more computers, a user interface for input, by a user, an indication of an audio modification to be made to the generated audio representation;
receiving, via the user interface, a user input, the user input indicating an audio modification and an extent indicator that indicates whether the audio modification is to be applied to the first section or to only one of the plurality of first subsections;
in response to the extent indicator indicating that the audio modification is to be applied to the first section:
generating updated audio representations for a plurality of subsections of the first section in accordance with the indication of the audio modification;
in response to the extent indicator indicating that the audio modification applies only to one of the plurality of first subsections:
generating an updated audio representation for the one of the plurality of first subsections in accordance with the received indication of the audio modification.
